(19) United States
(12) Patent Application Publication
(10) Pub. No.: US 2024/0151824 A1
(43) Pub. Date: May 9, 2024

(54) LASER PROJECTION MODULE

(71) Applicant: JIAXING UPHOTON OPTOELECTRONICS TECHNOLOGY CO., LTD., Tongxiang City (CN)

(72) Inventor: Zhentao FAN, Tongxiang City (CN)

(21) Appl. No.: 18/548,007

(22) PCT Filed: Jan. 19, 2022
(86) PCT No.: PCT/CN2022/072629

§ 371 Date: Aug. 25, 2023

(30) Foreign Application Priority Data
Feb. 26, 2021 (CN) 202110220184.2

(51) Int. Cl. G01S 7/481

(52) U.S. Cl. CPC G01S 7/4815

(57) ABSTRACT

A laser projection module is disclosed, which comprises a laser source and a diffractive optical element, and has a first operating mode and a second operating mode. In the first operating mode, a laser beam from the laser source irradiates the diffractive optical element in a first incident state, and the diffractive optical element projects a first light field comprising a patterned light field. In the second operating mode, the laser beam from the laser source irradiates the diffractive optical element in a second incident state different from the first incident state, and the diffractive optical element projects a second light field comprising a uniform light field. The laser projection module with different operating modes of the present disclosure integrates function of projecting a patterned light field and that of projecting a uniform light field.

### FILED OF THE INVENTION

The present disclosure generally relates to three-dimensional sensing technology, and in particular, relates to a laser projection module applicable to a three-dimensional sensing device.

### BACKGROUND

There are three main types of optical three-dimensional sensing technologies: binocular stereo vision, structured light technology, and TOF (Time of Flying) technology. Different technologies have different performance and may be suitable for different applications. In the field of consumer electronics (such as mobile phones), structured light technology and TOF technology are currently the most widely used. The principle of structured light technology is that: a laser source is used to project a coded and patterned light field; a pattern of the light field undergoes different deformations with a surface topography of an object; a image sensor captures the deformed pattern; and based on triangulation method, the corresponding parallax can be obtained by calculating deformation amount, so as to further obtain a depth information. The principle of TOF technology is to use a laser source to emit pulsed light or a continuous wave modulated by high-frequency intensity to the object, then receive the light reflected from the object, and calculate a depth information of the measured object by detecting a flight (round trip) time of the light.

Both structured light technology and TOF technology need to be realized based on a laser projection module that can project a predetermined light field. Structured light technology needs to project a patterned light field. TOF technology usually uses a flood light field, and can also use a patterned light field, such as a laser dot matrix.

In traditional three-dimensional sensing technology, the projection modules for projecting patterned light fields and for projecting flood light fields use different light sources and optical devices and are formed as separate components, respectively, and are used in combination in an application of three-dimensional sensing technology, causing problems such as low system integration, large volume, and high cost.

### SUMMARY

The object of the present disclosure is to provide a laser projection module, so as to at least partly overcome the deficiencies in the prior art.

According to one aspect of the present disclosure, a laser projection module is provided, which comprises a laser source and a diffractive optical element, the diffractive optical element projecting a predetermined light field under the irradiation of a laser beam from the laser source, wherein the laser projection module has a first operating mode and a second operating mode; in the first operating mode, the laser beam from the laser source irradiates the diffractive optical element in a first incident state, and the diffractive optical element projects a first light field, the first light field comprising at least a patterned light field; and in the second operating mode, the laser beam from the laser source irradiates the diffractive optical element in a second incident state different from the first incident state, and the diffractive optical element projects a second light field, the second light field comprising a uniform light field.

The first light field can be a light field of laser dot matrix.

Preferably, the laser source comprises a laser array, and laser emitted by the laser array forms a light source dot matrix; the first light field is a light field of laser dot matrix, and the light field of laser dot matrix is in a form of an array formed by periodically arranging the light source dot matrix as a unit.

Preferably, the laser source comprises an array of vertical cavity surface emitting lasers.

In some embodiments, at least one of the laser source and the diffractive optical element is configured to be movable along an optical axis to change an operating distance of the diffractive optical element relative to the laser source so that the laser projection module switches between the first operating mode and the second operating mode.

Preferably, in the first operating mode, the diffractive optical element and the laser source are at a first operating distance; in the second operating mode, the diffractive optical element and the laser source are at a second operating distance, and the second operating distance is smaller than the first operating distance.

Preferably, a difference between the first operating distance and the second operating distance is within 0.2˜3 mm.

The diffractive optical element can have a diffractive structure designed for divergent light. Preferably, the diffractive optical element has a non-periodic diffractive structure or has a diffractive structure with a period greater than the size of a light spot of the laser beam from the laser source irradiated on the diffractive optical element.

In other embodiments, the laser projection module further comprises a refractive optical element, which is arranged between the laser source and the diffractive optical element, the refractive optical element changes the direction of light incident on it, and the refractive optical element is configured to be movable along an optical axis to change an incident state of light irradiated on the diffractive optical element so that the laser projection module switches between the first operating mode and the second operating mode.

Preferably, in the first operating mode, the refractive optical element is positioned in such a way that light irradiated on the diffractive optical element is collimated light; and in the second operating mode, the refractive optical element is positioned in such a way that light irradiated on the diffractive optical element is non-collimated light.

Preferably, the diffractive optical element has a periodic diffractive structure designed for collimated light.

According to embodiments of the present disclosure, a laser projection module with different operating modes (projection modes) is provided, wherein by changing an incident state of a laser beam incident on a diffractive optical element, a first light field comprising a patterned light field and a second light field comprising a uniform light field can be respectively projected so that function of projecting the patterned light field and that of projecting the uniform light field are integrated into one body.

### BRIEF DESCRIPTION OF THE DRAWINGS

Other features, objects, and advantages of the present disclosure will become more apparent by reading the following detailed description of non-limitative embodiments with reference to the following drawings.

FIG. 1 is a schematic illustration of a laser projection module according to Embodiment 1 of the present disclosure;

FIG. 2 is a schematic illustration of a light source dot matrix of a laser array that can be used in a laser projection module according to embodiments of the present disclosure;

FIG. 3 shows an example of a first light field projected by a laser projection module according to embodiments of the present disclosure;

FIG. 4 shows an example of a second light field projected by a laser projection module according to embodiments of the present disclosure;

FIG. 5 is a schematic illustration of a laser projection module according to Embodiment 2 of the present disclosure; and

FIG. 6 is a schematic illustration of a laser projection module according to Embodiment 3 of the present disclosure.

### DETAILED DESCRIPTION

The present disclosure will be further described in detail in conjunction with drawings and embodiments. It should be understood that the specific embodiments described herein are only used to explain the related disclosure, but not to limit the disclosure. For the convenience of description, only the parts related to the disclosure are shown in the drawings.

It should be noted that the embodiments in the present disclosure and the features of the embodiments may be combined with each other without conflict. Description will be given in detail below with reference to the accompanying drawings and examples.

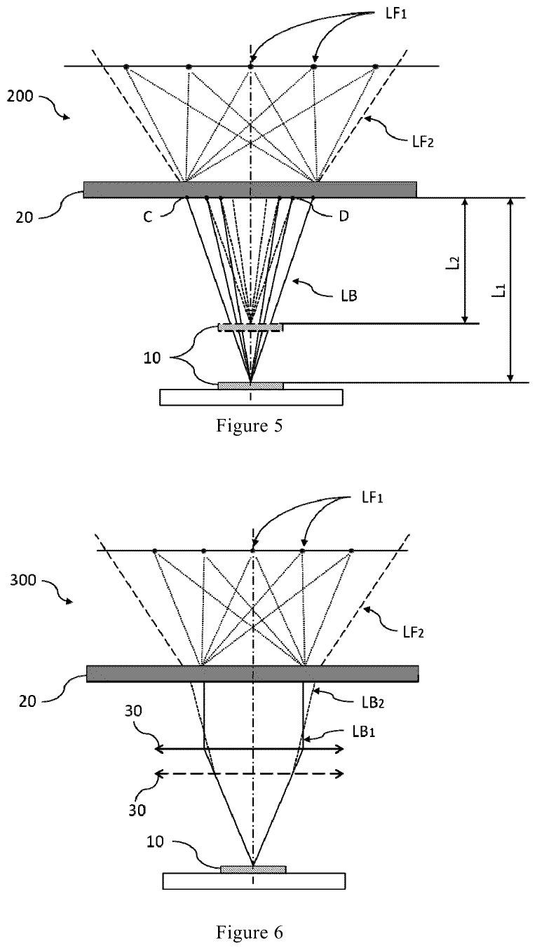

FIG. 1, FIG. 5, and FIG. 6 show laser projection modules according to different embodiments of the present disclosure, respectively. As will be described in detail below in conjunction with each figure, a laser projection module according to the embodiment of the present disclosure comprises a laser source 10 and a diffractive optical element (DOE) 20. The diffractive optical element 20 projects a predetermined light field under the irradiation of a laser beam LB from the laser source 10. The laser projection module has a first operating mode and a second operating mode. In the first operating mode, the laser beam from the laser source 10 irradiates the diffractive optical element 20 in a first incident state, and the diffractive optical element projects a first light field LF₁, the first light field LF₁ comprising at least a patterned light field. In the second operating mode, the laser beam LB (laser beams LB₁, LB₂) from the laser source 10 irradiates the diffractive optical element 20 in a second incident state different from the first incident state, and the diffractive optical element 20 projects a second light field LF₂, the second light field LF₂ comprising a uniform light field.

Here, “patterned light field” refers to a light field that forms a certain illumination pattern on a target projection plane (which can be an imaginary plane) AP, and the illumination pattern can comprise, for example, patterns formed by dots, lines, blocks of a specific shape, and their combinations and/or arrangements.

In a preferred embodiment, the patterned light field can be a light field of laser dot matrix. The light field of laser dot matrix can comprise a periodically arranged laser dot matrix or can be a speckle dot matrix with at least a certain aperiodicity. A speckle dot matrix with a certain aperiodicity may comprise, for example, a plurality of speckle dot matrix units arranged periodically, in which each speckle dot matrix unit has a plurality of speckle dots arranged aperiodically.

In some embodiments, the patterned light field can be a light field forming an illumination pattern having dot matrices and lines (for example, at least two straight lines that intersect). In other embodiments, the patterned light field can also be a light field that simply comprises line patterns.

According to embodiments of the present disclosure, the first light field comprises a patterned light field, but is not limited to be merely comprising a patterned light field. For example, the first light field can provide certain flood lighting while at the same time providing a patterned light field.

In the laser projection module according to the embodiment of the present disclosure, different operating modes (projection modes) are provided by changing the incident state of the laser beam incident on the diffractive optical element, so as to project the first light field comprising the patterned light field and the second light field comprising the uniform light field, respectively, thereby integrating the function of projecting the patterned light field and that of projecting the uniform light field. Since the diffractive optical element is used not only as a pattern generator but also as a light homogenizer, it helps to simplify the structure of the laser projection module and reduce cost.

Firstly, a laser projection module 100 according to Embodiment 1 of the present disclosure is introduced with reference to FIG. 1. FIG. 1 is a schematic illustration of the laser projection module 100. As shown in FIG. 1, in the laser projection module 100, a diffractive optical element 20 is configured to be movable along an optical axis direction to change an operating distance of the diffractive optical element 20 relative to a laser source 10, so that the laser projection module 100 switches between a first operating mode and a second operating mode.

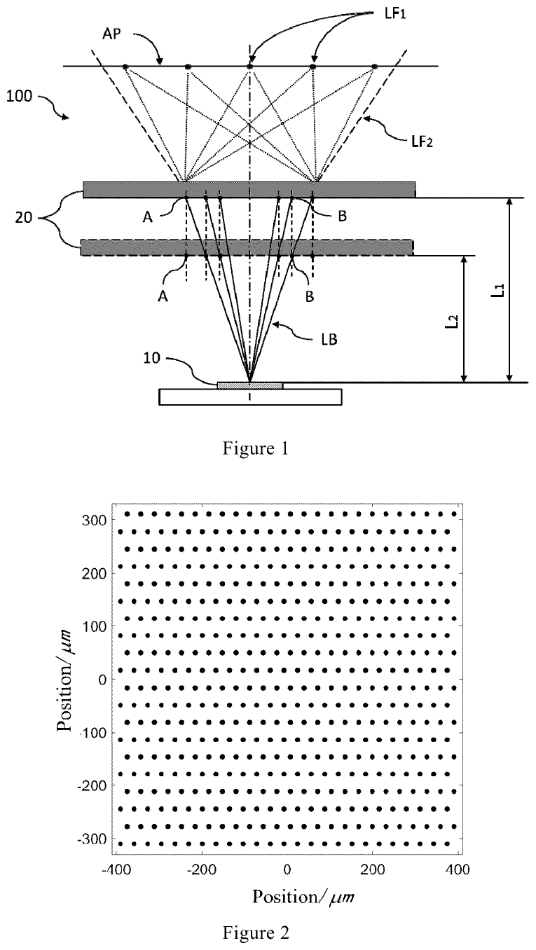

Preferably, the laser source 10 can comprise a VCSEL (Vertical Cavity Surface Emitting Laser). Of course, the present disclosure is not limited in this respect, and the laser source 10 can comprise other types of lasers, such as LD (Laser Diode), etc. Preferably, the laser source 10 can comprise a laser array composed of a plurality of lasers, for example, a VCSEL array. The light emitted by the laser array forms a light source dot matrix. As an example only, FIG. 2 shows an example of a light source dot matrix of a laser array that can be used in the laser projection module.

It should be understood that although it is shown in FIG. 1 that no other optical elements are arranged between the laser light source 10 and the diffractive optical element 20 the present disclosure is not limited to the arrangement without other optical elements between the laser light source and the diffractive optical element, as long as the incident state of the laser beam incident on the diffractive optical element 20 can be changed by moving the optical element along the optical axis. For example, a beam shaping element for controlling the divergence angle of the laser beam emitted from the laser source 10 can be provided between the laser source 10 and the diffractive optical element 20, and the beam shaping element is configured to be movable along the optical axis to change an operating distance of the beam shaping element relative to the laser source 10, thereby changing the incident state of the laser beam incident on the diffractive optical element 20 so that the laser projection module 100 switches between the first operating mode and the second operating mode. It will be understood that, according to this embodiment, when only the diffractive optical element 20 moves, the laser beam LB irradiated on the diffractive optical element 20 is a non-collimated beam.

In the example shown in FIG. 1, the diffractive optical element 20 moves along the optical axis direction, so that in the first operating mode, the diffractive optical element 20 is at a first operating distance L₁ from the laser light source 10; in the second operating mode, the diffractive optical element 20 is at a second operating distance L₂ from the laser light source 10. The second operating distance L₂ is different from the first operating distance L₁. Although the light beam LB itself from the laser source 10 does not change, for the same point on the diffractive optical element 20, the incident state of the light irradiated thereon changes, since the distance of the diffractive optical element 20 relative to the laser source 10 changes. For example, in the example shown in FIG. 1, for the same point A on the diffractive optical element 20, light is incident thereon at the first operating distance L₁, but no light is incident thereon at the second operating distance L₂. As another example, for the same point B on the diffractive optical element 20, the incident angles of light incident on it are different under the first operating distance L₁ and the second operating distance L₂, and if the light intensity distribution of the light beam LB along the cross-section of the light beam is not uniform, the intensity of the light incident on the point B at different operating distances can also be different. In brief, it can be seen that according to this embodiment, by changing the operating distance of the diffractive optical element 20 relative to the laser source 10, the incident state of the laser beam LB irradiating the diffractive optical element 20 can be changed, so as to switch between the first operating mode and the second operating mode.

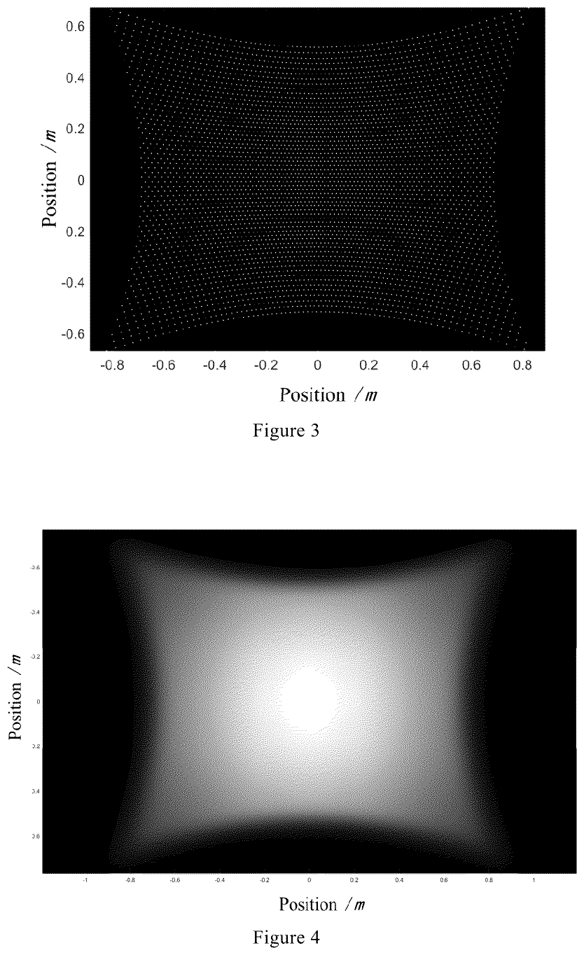

For ease of understanding, FIG. 3 and FIG. 4 show respectively examples of a first light field and a second light field projected by a laser projection module according to embodiments of the present disclosure. In the example shown in FIG. 3, the first light field is a light field of laser dot matrix, and the light field of laser dot matrix is in a form of an array formed by periodically arranging (for example, in 3×3 array arrangement) of a light source dot matrix (for example, a light source dot matrix shown in FIG. 2) of a laser array used as the laser source, as a unit. The second light field shown in FIG. 4 is a substantially rectangular and substantially uniform light field. It should be understood that this is merely exemplary but not restrictive.

According to the embodiment shown in FIG. 1 of the present disclosure, the diffractive optical element 20 for the laser projection module is designed for divergent light and for the first light field to be projected, specially designed according to the patterned light field, such as a light field of laser dot matrix; and the diffractive optical element 20 can be further optimized in consideration of the second light field to be projected. The designed diffractive optical element 20 has an optimal operating distance corresponding to the first light field to be projected, that is, the first operating distance L₁. When the distance of the diffractive optical element 20 relative to the laser light source 10 deviates from the first operating distance L₁, the illumination pattern of the first light field will be diffused until the distance changes to the second operating distance L₂ to project a substantially uniform light field. More specifically, when utilizing computer-aided programming to design the diffractive optical element 20 in the embodiment shown in FIG. 1, the parameters of the incident light field are set to have a divergence angle consistent with the VCSEL laser source, and the target image of the diffractive optical element is set to a 3×3 dot matrix, and the 3×3 target image dot matrix is convolved with the light source dot matrix formed by the VCSEL laser array to obtain the light field of laser dot matrix as shown in FIG. 3, and according to the size requirements of the laser projection module, an operating distance between the diffractive optical element 20 and the laser source is determined, that is, the first operating distance. According to the various parameters set above, a specific phase distribution of the diffractive optical element 20 can be calculated by using a computational assistant program, and the diffractive optical element 20 can be processed and manufactured accordingly. Since the diffractive optical element 20 in this embodiment is designed for divergent light and is designed to project a dot matrix by using the first operating distance as the distance parameter, it can be understood that the diffractive optical element 20 can project clear light field of laser dot matrix when working at the first operating distance. That is, when the diffractive optical element 20 works at the first operating distance, the light source dot matrix formed by the VCSEL laser array can be clearly imaged in the form of convolution with a 3×3 dot matrix. That is to say, the first operating distance is the optimal operating distance for the diffractive optical element 20 to project the first light field, that is, the light field of laser dot matrix. When the operating distance of the diffractive optical element 20 deviates from the first operating distance, the laser dots in the projected light field of laser dot matrix will undergo dispersion. As the operating distance deviation increases, the laser dots will increase in size and disperse into large spots, and the projected light field of laser dot matrix will become blurred. When the operating distance deviates to a certain extent, the increase in the spot size will make the adjacent spots overlap and cover the entire target field of view to form a uniform light field. The operating distance at this time is the second operating distance. It should be pointed out here that, as those skilled in the art can understand, the value of the second operating distance can be selected within a certain range of values. In addition, in order to reduce the overall size of the laser projection module, especially the size along the optical axis, the second operating distance L₂ is preferably smaller than the first operating distance L₁.

In some embodiments where the first light field is a light field of laser dot matrix, the first operating distance can be within a range of 1.5 mm to 5 mm, for example. Considering the compactness of the structure and the flexibility of the design, a difference between the first operating distance L₁ and the second operating distance L₂ is preferably in the range of 0.2-3 mm. In the embodiment shown in FIG. 3 and FIG. 4, the first operating distance L₁, that is, the distance between the diffractive optical element 20 and the laser source 10 when projecting the light field of laser dot matrix shown in FIG. 3, is 2.1 mm, and the second operating distance L₂, that is, the distance between the diffractive optical element 20 and the laser source 10 when projecting the uniform light field shown in FIG. 4, is 1.5 mm.

FIG. 5 schematically shows a laser projection module 200 according to Embodiment 2 of the present disclosure. As shown in FIG. 5, the laser projection module 200 according to Embodiment 2 of the present disclosure has substantially the same structure as the laser projection module 100 according to Embodiment 1 of the present disclosure, with difference lies in that, in the laser projection module 200, the laser source 10 instead of the diffractive optical element 20 is configured to move along the optical axis, thus changing the operating distance of the diffractive optical element 20 relative to the laser source 10, so that the laser projection module 200 switches between the first and second operating modes.

Similar to the laser projection module 100, as long as the incident state of the laser beam incident on the diffractive optical element 20 can be changed by moving the optical element along the optical axis, the laser projection module 200 is not limited to the arrangement without other optical elements between the laser light source and the diffractive optical element. For example, a beam shaping element for controlling the divergence angle of the laser beam emitted from the laser source 10 can be provided between the laser light source 10 and the diffractive optical element 20. It can be understood that, according to this embodiment, when only the laser source 10 moves, the laser beam LB irradiated on the diffractive optical element 20 is a non-collimated beam.

In the example shown in FIG. 5, the laser source 10 moves along the optical axis direction, so that in the first operating mode, the diffractive optical element 20 is separated from the laser source 10 by a first operating distance L₁; and in the second operating mode, the diffractive optical element 20 is separated from the laser source 10 by a second operating distance L₂. The second operating distance L₂ is different from the first operating distance L₁. Since the distance between the diffractive optical element 20 and the laser source 10 changes, the incident state of light irradiating the same point on the diffractive optical element 20 changes as well. For example, in the example shown in FIG. 5, for the same point C on the diffractive optical element 20, light is incident thereon at the first operating distance L₁, but no light is incident thereon at the second operating distance L₂. As another example, for the same point D on the diffractive optical element 20, the incident angles of light incident on it are different under the first operating distance L₁ and the second operating distance L₂, and if the light intensity distribution of the light beam LB along the cross-section of the light beam is not uniform, so the intensity of light incident on point D at different operating distances can also be different. In brief, it can be seen that according to this embodiment, by changing the operating distance of the diffractive optical element 20 relative to the laser source 10, the incident state of the laser beam LB irradiating the diffractive optical element 20 can be changed, so as to switch between the first operating mode and the second operating mode.

The design of the laser source 10, the diffractive optical element 20, the first and second operating distances and the desired projected first and second light fields of the laser projection module 200 can be the same as or similar to those in the laser projection module 100, which will not be repeated here.

It should be understood that although not shown, in the laser projection module according to other embodiments of the present disclosure, the laser source 10 and the diffractive optical element 20 can both be configured to be movable along the optical axis to change the distance between the two, so as to switch between the first operating mode and the second operating mode.

In the laser projection module according to Embodiment 1 and Embodiment 2 of the present disclosure, preferably, the diffractive optical element has a diffractive structure designed for divergent light. In particular, the diffractive optical element preferably has a non-periodic diffractive structure or a diffractive structure with a period greater than the size of a light spot irradiated on the diffractive optical element by a laser beam from a laser light source.

FIG. 6 is a schematic illustration of a laser projection module 300 according to Embodiment 3 of the present disclosure. As shown in FIG. 6, the laser projection module 300 comprises a refractive optical element (such as a lens) 30 in addition to a laser source 10 and a diffractive optical element 20. According to the present embodiment, the refractive optical element 30 is arranged between the laser source 10 and the diffractive optical element 20, the refractive optical element 30 changes the direction of light incident on it, and the refractive optical element 30 is configured to be movable along the optical axis direction to change an incident state of light irradiated on the diffractive optical element 20 so that the laser projection module can switch between the first operating mode and the second operating mode.

In the example shown in FIG. 6, the movement of the refractive optical element 30 along the optical axis changes the converging state of the laser beam irradiated on the diffractive optical element 20 so that in the first operating mode, the light irradiated on the diffractive optical element 20 is collimated light (light beam LB 1 shown in FIG. 6); and in the second operating mode, the light irradiated on the diffractive optical element 20 is non-collimated light (light beam LB₂ shown in FIG. 6).

It should be understood that, in other implementation manners, according to the present embodiment, the movement of the refractive optical element 30 along the optical axis can make the light irradiated on the diffractive optical element 20 in the first operating mode be non-collimated light, while the light irradiated on the diffractive optical element 20 in the second operating mode be collimated light; or, the movement of the refractive optical element 30 along the optical axis can make the light irradiated on the diffractive optical element 20 in the first and second operating modes be non-collimated light with different incident states relative to the diffractive optical element 20, such as having different divergence angles.

In the embodiment in which the light irradiated on the diffractive optical element 20 in the first operating mode is collimated light, the diffractive optical element 20 preferably has a periodic diffractive structure with a small-period dense arrangement designed for collimated light.

In order to drive the movement of optical devices such as the laser source 10, the diffractive optical element 20, and/or the refractive optical element 30 in the laser projection module according to embodiments of the present disclosure, different drive methods such as purely mechanical drive, electromagnetic drive, or electrostatic drive can be used. As an example, a voice coil motor can be used to drive the movement of the optical device by using electromagnetic force. The corresponding driving device can be directly fixedly connected with the optical device that needs to be moved or can be connected with the optical device through a movable bracket as an intermedia, so as to control the movement of the optical device. It should be understood that the laser projection module according to the embodiment of the present disclosure may or may not integrate such a driving device. In the case that the laser projection module does not comprise a driving device, the driving device can be assembled with the laser projection module in the equipment using the laser projection module, so as to drive the above-mentioned optical device.

The above description is merely an illustration of the preferred embodiments of the present disclosure and the applied technical principles. Those skilled in the art should understand that the scope of the disclosure involved in the present disclosure is not limited to the technical solution formed by the specific combination of the above technical features, but also covers other technical solutions formed by any combination of the above technical features or their equivalent features without departing from the inventive concept. For example, the technical solution is formed by replacing the above features with (but not limited to) the technical features with similar functions disclosed in the present disclosure.

1. A laser projection module, comprising:
a laser source; and
a diffractive optical element, which projects a predetermined light field with irradiation of a laser beam from the laser source,
wherein the laser projection module has a first operating mode and a second operating mode, wherein in the first operating mode, the laser beam from the laser source irradiates the diffractive optical element in a first incident state, and the diffractive optical element projects a first light field, the first light field comprising at least a patterned light field; and in the second operating mode, the laser beam from the laser source irradiates the diffractive optical element in a second incident state different from the first incident state, and the diffractive optical element projects a second light field, the second light field comprising a uniform light field.

2. The laser projection module of claim 1, wherein the first light field is a light field of laser dot matrix.

3. The laser projection module of claim 1, wherein the laser source comprises a laser array, and laser emitted by the laser array forms a light source dot matrix; and
the first light field is a light field of laser dot matrix, and the light field of laser dot matrix is in a form of an array formed by periodically arranging the light source dot matrix as a unit.

4. The laser projection module of claim 2, wherein the laser source comprises an array of vertical cavity surface emitting lasers.

5. The laser projection module of claim 1, wherein at least one of the laser source and the diffractive optical element is configured to be movable along an optical axis to change a operating distance of the diffractive optical element relative to the laser source so that the laser projection module switches between the first operating mode and the second operating mode.

6. The laser projection module of claim 5, wherein, in the first operating mode, the diffractive optical element and the laser source are at a first operating distance; in the second operating mode, the diffractive optical element and the laser source are at a second operating distance, and the second operating distance is smaller than the first operating distance.

7. The laser projection module of claim 6, wherein a difference between the first operating distance and the second operating distance is within 0.2-3 mm.

8. The laser projection module of claim 5, wherein the diffractive optical element has a diffractive structure designed for divergent light.

9. The laser projection module of claim 8, wherein the diffractive optical element has a non-periodic diffractive structure.

10. The laser projection module of claim 1, further comprising a refractive optical element, which is arranged between the laser source and the diffractive optical element, wherein the refractive optical element changes a direction of light incident on it, and the refractive optical element is configured to be movable along an optical axis to change an incident state of light irradiated on the diffractive optical element, so that the laser projection module switches between the first operating mode and the second operating mode.

11. The laser projection module of claim 10, wherein in the first operating mode, the refractive optical element is positioned in such a way that light irradiated on the diffractive optical element is collimated light; and in the second operating mode, the refractive optical element is positioned in such a way that light irradiated on the diffractive optical element is non-collimated light.

12. The laser projection module of claim 11, wherein the diffractive optical element has a periodic diffractive structure designed for collimated light.

13. The laser projection module of claim 2, wherein at least one of the laser source and the diffractive optical element is configured to be movable along an optical axis to change a operating distance of the diffractive optical element relative to the laser source so that the laser projection module switches between the first operating mode and the second operating mode.

14. The laser projection module of claim 3, wherein at least one of the laser source and the diffractive optical element is configured to be movable along an optical axis to change a operating distance of the diffractive optical element relative to the laser source so that the laser projection module switches between the first operating mode and the second operating mode.

15. The laser projection module of claim 4, wherein at least one of the laser source and the diffractive optical element is configured to be movable along an optical axis to change a operating distance of the diffractive optical element relative to the laser source so that the laser projection module switches between the first operating mode and the second operating mode.

16. The laser projection module of claim 13, wherein, in the first operating mode, the diffractive optical element and the laser source are at a first operating distance; in the second operating mode, the diffractive optical element and the laser source are at a second operating distance, and the second operating distance is smaller than the first operating distance.

17. The laser projection module of claim 8, wherein the diffractive optical element has a diffractive structure with a period greater than the size of a light spot of the laser beam from the laser source irradiated on the diffractive optical element.

18. The laser projection module of claim 2, further comprising a refractive optical element, which is arranged between the laser source and the diffractive optical element, wherein the refractive optical element changes a direction of light incident on it, and the refractive optical element is configured to be movable along an optical axis to change an incident state of light irradiated on the diffractive optical element, so that the laser projection module switches between the first operating mode and the second operating mode.

19. The laser projection module of claim 3, further comprising a refractive optical element, which is arranged between the laser source and the diffractive optical element, wherein the refractive optical element changes a direction of light incident on it, and the refractive optical element is configured to be movable along an optical axis to change an incident state of light irradiated on the diffractive optical element, so that the laser projection module switches between the first operating mode and the second operating mode.

20. The laser projection module of claim 4, further comprising a refractive optical element, which is arranged between the laser source and the diffractive optical element, wherein the refractive optical element changes a direction of light incident on it, and the refractive optical element is configured to be movable along an optical axis to change an incident state of light irradiated on the diffractive optical element, so that the laser projection module switches between the first operating mode and the second operating mode.
